(19) United States
(12) Patent Application Publication
(10) Pub. No.: US 2018/0189303 A1
(43) Pub. Date: Jul. 5, 2018

(54) PUBLISHER-SUBSCRIBER SYSTEM WITH PUBLISHER BASED TAXONOMY FOR MULTI-DATA SOURCE PUBLISHER

(71) Applicant: CA, Inc., New York, NY (US)

(72) Inventor: Serguei Mankovskii, Morgan Hill, CA (US)

(21) Appl. No.: 15/393,541

(22) Filed: Dec. 29, 2016

(51) Int. Cl. G06F 17/30; H04L 29/08

(52) U.S. Cl. CPC G06F 17/3089; G06F 17/30864; H04L 67/26

(57) ABSTRACT

A publisher-subscriber system can be designed that roots information of a publisher associated with multiple data sources, organizes the data of the multiple data sources into sub-channels based on a publisher defined taxonomy, and couples the published information with a publisher's online presence. Rooting the publishing of information to a publisher instead of a topic or content, for example, facilitates subscriber navigation of publishers that publish same or similar types of information while also allowing diverse information from numerous data sources to be organized by publisher defined information taxonomy across the multiple data sources.

### BACKGROUND

The disclosure generally relates to the field of data processing, and more particularly to multicomputer data transferring.

A publisher/subscriber (pub/sub) system is a system that implements a pub/sub messaging pattern (also referred to as pub/sub communication model). With a pub/sub messaging pattern, a publisher publishes information (e.g., a message or event) to subscribers via an intermediary, sometimes referred to as a broker. Thus, publishers and subscribers are decoupled from each other. In a topic-based pub/sub system, a publisher identifies information by topic and publishes the information to a broker. The information from a publisher includes a topic designation and the payload information (or payload data). A subscriber subscribes to one or more topics with the broker. The broker filters and forwards information to subscribers according to their subscriptions. Other types of pub/sub communication models include content-based filtering and type-based filtering of information.

A pub/sub system establishes connections between publishers/subscribers and a broker(s), and communicates messages according to a protocol, such as the Message Queuing Telemetry Transport (MQTT) protocol. The Organization for the Advancement of Structured Information Standards (OASIS) describes the MQTT protocol as a lightweight client-server publish/subscribe messaging transport protocol. The protocol was originally created to collect data from multiple devices while using limited bandwidth to provide the data to multiple subscribers. These characteristics of the MQTT protocol lead to its use in Internet of Things (IoT) contexts where a small code footprint is desirable and/or network bandwidth is at a premium.

### BRIEF DESCRIPTION OF THE DRAWINGS

Embodiments of the disclosure may be better understood by referencing the accompanying drawings.

FIG. 1 is a conceptual diagram of a publisher-subscriber system that publishes information according to information taxonomies based on attributes of publishers with multiple data sources.

FIG. 2 is a flowchart of example operations for a publisher node to establish a publisher channel in a publisher-subscriber system.

FIG. 3 is a flowchart of example operations for a broker to create a publisher channel.

FIG. 4 is a flowchart of example operations for a broker to create a publisher sub-channel.

FIG. 5 is a flowchart of example operations for a subscriber application to discover and subscribe to a publisher sub-channel.

FIG. 6 depicts an example computer system with a publisher node or broker according to the previously described paradigm.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

Overview

A publisher-subscriber system can be designed that roots information of a publisher associated with multiple data sources, organizes the data of the multiple data sources into sub-channels based on a publisher defined taxonomy, and couples the published information with a publisher's online presence. Rooting the publishing of information to a publisher instead of a topic or content, for example, facilitates subscriber navigation of publishers that publish same or similar types of information while also allowing diverse information from numerous data sources to be organized by publisher defined information taxonomy across the multiple data sources. A publisher node creates searchable metadata that describes the publisher associated with multiple data sources (e.g., multiple sensors). The publisher node obtains an identifier for the publisher that is unique with respect to the publisher class that includes the publisher. The publisher node provides the class unique identifier and the searchable metadata for publication to a domain associated with the publisher (e.g., website). The publisher node also provides the unique identifier to an intermediary notification service (“broker”) along with an indication to create a publisher channel. The unique identifier of the publisher functions as a root of publisher sub-channels that conform to a hierarchical organization of the information published by the publisher based on characteristics of the publisher (“publisher based information taxonomy”). When the publisher communicates data to the broker, the broker creates or updates the appropriate sub-channel according to the publisher based information taxonomy. To subscribe to sub-channels of a publisher of in this system, a subscriber application can search the internet for information of the publisher and select from multiple publishers within the same publisher class to obtain the publisher identifier. With the publisher identifier, the subscriber application can determine the sub-channels of the publisher and subscribe to one or more of the sub-channels of the publisher.

Example Illustrations

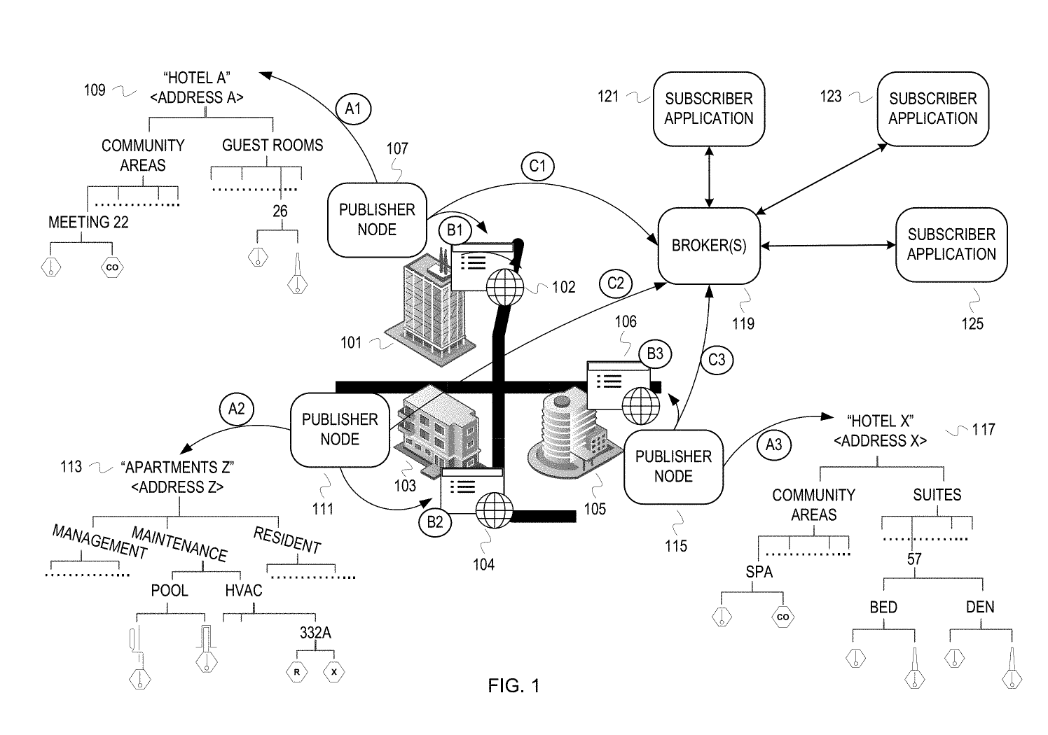

FIG. 1 is a conceptual diagram of a publisher-subscriber system that publishes information according to information taxonomies based on attributes of publishers with multiple data sources. FIG. 1 depicts three multi-person lodgings: a hotel 101, an apartment complex 103, and a hotel 105. Each of these lodgings is associated with a publisher node and a web presence. The hotel 101 is associated with a publisher node 107 and a web presence 102; the apartment complex 103 is associated with a publisher node 111 and a web presence 104; and the hotel 105 is associated with a publisher node 115 and a web presence 106. Describing the lodgings as “associated” with a publisher node and a web presence allows for the various possibilities of deployment. An owner or managing company of the hotel 101, for instance, does not necessarily maintain the web pages and underlying website code of the web presence 102 at the hotel 101. Each of the web presence 102, the web presence 104, and the web presence 106 refers to a defined realm of administrative autonomy, authority, or control within the internet (“internet realm”) of the corresponding entity. Thus, the web presence 102 refers to one or more internet realms associated with the hotel 101. Similarly, the web presence 104 refers to one or more internet realms associated with the apartments 103 and the web presence 106 refers to one or more internet realms associated with the hotel 105.

The publisher-subscriber system illustrated in FIG. 1 includes the publisher node 107, the publisher node 111, the publisher node 115, a broker(s) 119, subscriber application 121, subscriber application 123, and subscriber application 125. Any number of subscriber applications and publisher nodes can constitute the publisher-subscriber system. The broker(s) 119 can be a single broker node (i.e., an executing instance of broker program code). However, the broker(s) 119 is likely multiple brokers that maintain shared data repositories of published information with designated writers and load balance serving subscriber requests.

FIG. 1 is annotated with a series of letters A-C. These letters represent stages of operations that are each broken down further into sub-stages 1-3 for each of the publishers. Although these stages are ordered for this example, the stages illustrate one example to aid in understanding this disclosure and should not be used to limit the claims. The sub-stages can occur in a different order and can occur concurrently. Subject matter falling within the scope of the claims can vary with respect to the order and some of the operations.

Across stages A1-A3, the publisher nodes 107, 111, 115 determine information taxonomy for the information from multiple data sources of the publishers. The publisher node 107 determines information taxonomy 109 for various sensors of the hotel 101 at a stage A1. In this illustration, the data sources of the hotel 101 include temperature sensors, air quality sensors, and fire sensors. The information taxonomy 109 is based on attributes of the hotel 101, such as community areas and rooms. The information taxonomy 109 indicates a meeting room 22 that has been classified as a community area is associated with two sensors: a space temperature sensor and an air quality sensor. The information taxonomy classifies a room number 26 as a guest room associated with two sensors: a space temperature sensor and a fire sensor. The hotel 101, which is identified as a “Hotel A”, has a class unique identifier that is a combination of the name of the hotel 101 and its address. The information taxonomy 109 can be defined separately from the publisher node 107 and provided to the publisher node (e.g., defined in a file) or the publisher node 107 can be used to create the information taxonomy 109.

The publisher node 111 and the publisher node 115 determine information taxonomy 113 and information taxonomy 117, respectively. At stage A2, the publisher node 107 determines the information taxonomy 113 for various sensors of the apartments 103 (named Apartments Z), which include water temperature sensors, chemical sensors, HVAC refrigerant sensors, and temperature differential sensors. The information taxonomy 113 is based on attributes of the apartments 103 and classifies the data from the sensors at a top level as management, maintenance, or resident information. The information taxonomy 113 classifies information based on data from the pool sensors (a water temperature sensor and a chemical sensor) as pool maintenance information. The information taxonomy 113 classifies information based on data from HVAC sensors of an HVAC unit 332A (a refrigerant sensor and a temperature differential sensor) as HVAC maintenance information. The apartments 103 have a class unique identifier that is a combination of the name of the apartments 103 and its address. At stage A3, the publisher node 115 determines the information taxonomy 117 for various sensors of the hotel 105 (named Hotel X), which include space temperature sensors, air quality sensors, and fire sensors. The information taxonomy 117 is based on attributes of the hotel 105 and classifies the information based on data from the sensors at a top level into community areas information and suites information. In contrast to the information taxonomy 109 for the hotel 101, the information taxonomy 117 classifies information by rooms of suites and the community areas include a spa. The information taxonomy 117 classifies information based on data from the sensors in the spa (a space temperature sensor and an air quality sensor) as spa space temperature information and air quality spa information. The information taxonomy 117 classifies information based on data from sensors in suites into information by room within a suite. For instance, the information taxonomy 117 classifies information based on sensors in a suite 57 (a space temperature sensors and fire sensors) into bedroom information and den information. The hotel 105 has a class unique identifier that is a combination of the name of the hotel 105 and its address.

Across stages B1-B3, the publisher nodes 107, 111, 115 publish the class unique identifiers of the corresponding lodgings to the corresponding web presences. At stage B1, the publisher node 107 publishes the class unique identifier of the hotel 101 to the web presence 102. At stage B2, the publisher node 111 publishes the class unique identifier of the apartments 103 to the web presence 104. At stage B3, the publisher node 115 publishes the class unique identifier of the hotel 105 to the web presence 106.The subscriber applications 121, 123, 125 can later retrieve the publisher identifiers to discover the publisher channels from the broker 119.

Across stages C1-C3, the publisher nodes 107, 11, 115 communicate indications of the class unique identifiers of the publishers and the object taxonomies to the broker(s) 119. At stage Cl, the publisher node 107 communicates the class unique identifier of the hotel 101 or a compact/secure value (e.g., hash value) computed from the class unique identifier to the broker (s) 119. The broker 119 uses the communicated class unique identifier or computed value to create a publisher channel for the hotel 101. The publisher node 107 also communicates the information taxonomy 109 to the broker 119. When information (e.g., periodically measured temperature in room 26) is later communicated from the publisher node 107 to the broker 119, the broker 119 updates a room 26 temperature sub-channel with the information based on the communicated information taxonomy 109. At stage C2, the publisher node 111 communicates the class unique identifier of the apartments 103 or a compact/secure value computed from the class unique identifier to the broker (s) 119. The broker 119 uses the communicated class unique identifier or computed value to create a publisher channel for the apartments 103. The publisher node 111 also communicates the information taxonomy 113 to the broker 119. When information (e.g., periodically measured pool temperature) is later communicated from the publisher node 111 to the broker 119, the broker 119 updates a pool temperature sub-channel with the information based on the communicated information taxonomy 113. At stage C3, the publisher node 115 communicates the class unique identifier of the hotel 105 or a compact/secure value computed from the class unique identifier to the broker (s) 119. The broker 119 uses the communicated class unique identifier or computed value to create a publisher channel for the hotel 105. The publisher node 115 also communicates the information taxonomy 117 to the broker 119. When information (e.g., periodically measured air quality in the spa) is later communicated from the publisher node 115 to the broker 119, the broker 119 updates a spa air quality sub-channel with the information based on the communicated information taxonomy 117.

After the stages A-C, the subscriber applications 121, 123, 125 can discover the publishers and subscribe to a sub-channel within a publisher channel. For instance, the subscriber application 121 can be a mobile device application that presents atmosphere information for lodgings. The subscriber application 121 can search for lodgings based on geographic location of a hosting mobile device or an input location. The subscriber application 121 can select from discovered lodgings based on detected selection in a user interface or profile settings (e.g., hotel room registration information). Presuming the hotel 101 has been selected, the subscriber application 121 can then search for the publisher identifier of the hotel 101, which will be retrieved from the web presence 102. The subscriber application 121 can then submit the publisher identifier to the broker 119. In response, the broker 119 can communicate the information taxonomy 109 or a part of the information taxonomy 109 to the subscriber application 121. Based on the communicated information taxonomy 109, the subscriber application 121 can request subscription to one or more sub-channels of the Hotel A publisher channel.

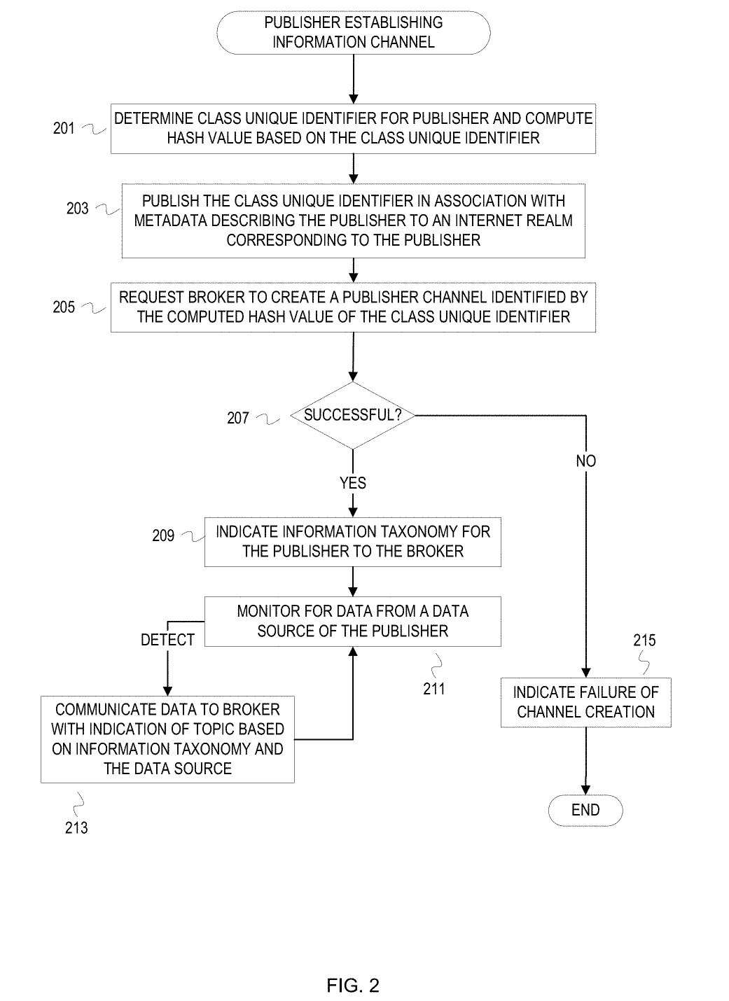

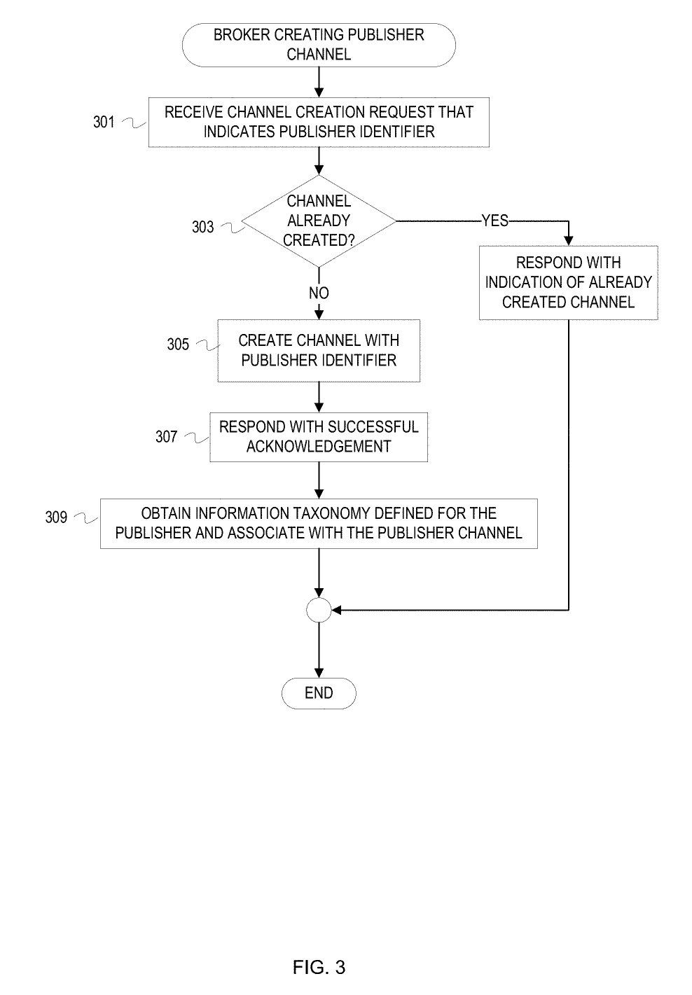

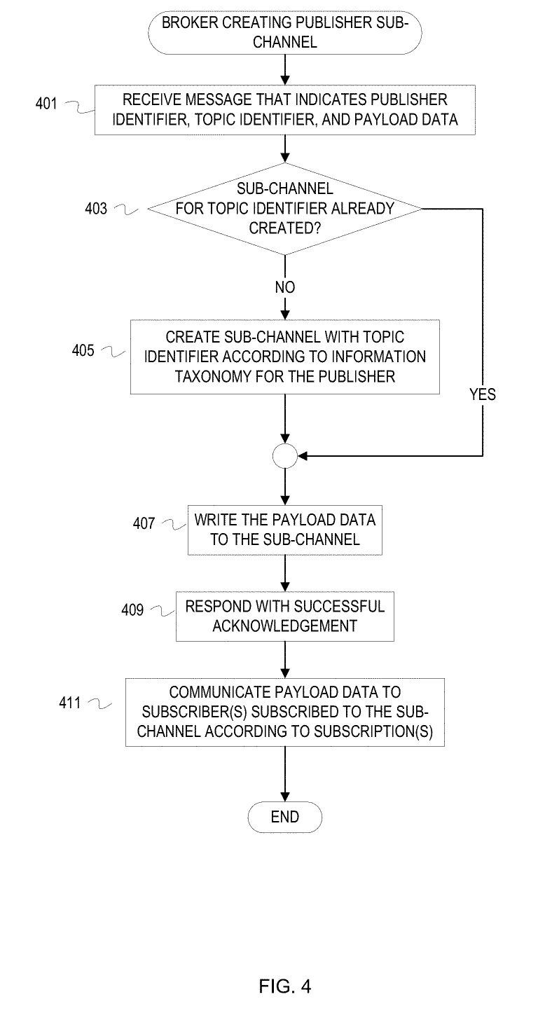

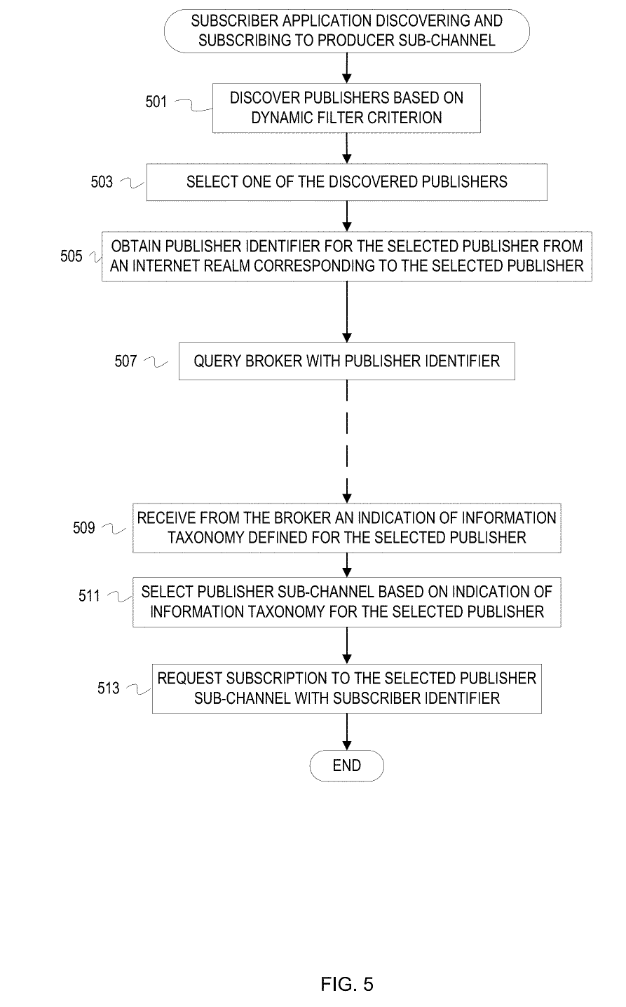

FIG. 1 provided a specific example illustration of a publisher-subscriber system. FIGS. 2-4 are flowcharts of example operations that are not bound to a lodging example. FIG. 2 corresponds to example operations by a publisher node. FIGS. 3-4 correspond to example operations by an intermediary notification service or broker. FIG. 5 corresponds to example operations by a subscriber application.

FIG. 2 is a flowchart of example operations for a publisher node to establish a publisher channel in a publisher-subscriber system. A publisher node can be an executing instance of program code that operates as a client with respect to an intermediary notification service and includes program code to generate calls to application program interface (API) defined function calls within hypertext transport protocol (HTTP) messages for requesting channel creation and sending information to the intermediary notification service or broker as records, messages with payload data, etc. The publisher node also embodies a data collection service that collects data from sensors or interfaces with a data collection service.

The publisher node determines a class unique identifier for a publisher corresponding to the publisher node and computes a hash value based on the class unique identifier (201). As previously mentioned, the class unique identifier is an identifier that uniquely identifies a publisher within a class of publishers. In the example illustration of FIG. 1, the class of publishers was multi-person lodgings and the class unique identifier was a combination of the lodging name and physical address. As another example, a class of publishers could be automobiles and a class unique identifier can be a vehicle identification number (VIN). The publisher identifier corresponds to the publisher instead of a specific data source since the publisher is associated with multiple data sources. The publisher node can determine the class unique identifier for a publisher with different techniques. The publisher node can include a user interface to receive the class unique identifier as input. The publisher node can interface with a backend system of the publisher to obtain the class unique identifier or access a directory or database of canonical identifiers for a publisher class. In some embodiments, a publisher class based specification can specify parameters for class unique identifiers to facilitate creation of the class unique identifier by the publisher node. For instance, a publisher specification for a building class of publishers can specify construction parameters as a physical address of a building or a physical address of a building concatenated with a name of an owner or management company of the building. The publisher node computes the hash value of the class unique identifier (or interacts with a hashing module to compute the hash value) for communication to a broker. The publisher node uses the hash value as a more compact version of the class unique identifier that reduces likelihood of parameter or message constraints imposed by the broker.

The publisher node publishes the class unique identifier in association with metadata describing the publisher to an internet realm corresponding to the publisher (203). The publisher node can send a POST request, for example, to an internet realm of the publisher (e.g., web service identified by uniform resource locator). Posting the class unique identifier in association with metadata describing the publisher leverages an existing internet realm of the publisher to facilitate discovery of the data sources of the publisher available for subscription. For example, a subscriber application can submit keywords related to a class of publishers to a search engine that will return results based on matches with the publisher metadata.

The publisher node requests a broker to create a publisher channel identified by the hash value derived from the class unique identifier of the publisher (205). The publisher node forms a request according to a message specification and/or API function call defined for the broker. The request includes an argument indicating that the request is for channel creation and an argument that indicates the hash value to be used as an identifier for the publisher channel. If the channel creation is not successful (e.g., a failure response is received by the publisher node), then the publisher node indicates the failure of the channel creation (e.g., presents a notification in a user interface or logs the failure) (215).

When channel creation is successful, the publisher node indicates information taxonomy for the publisher to the broker (209). The publisher node can retrieve the information taxonomy from a specified location (e.g., input via an interface, configured database location, etc.). Using the example of an automobile as an example of a publisher, the automobile manufacturer can create the information taxonomy based on manufacture of the automobile. The information taxonomy can be stored as a file accessible to the publisher node. In some embodiments, the publisher node can include program code that allows the information taxonomy to be defined with the publisher node, via a user interface for example. The publisher node can indicate the information taxonomy for the publisher to a broker by communicating the information taxonomy (e.g., uploading an information taxonomy file to the broker) or communicating a location at which the information taxonomy can be accessed (e.g., an internet address). A publisher node can associate a security policy to an information taxonomy file or annotate an information taxonomy file with security restrictions. For example, a publisher node may require authentication of a subscriber for particular sub-channels. A publisher node can communicate directives to the broker to hide or limit viewing of portions of an information taxonomy of a publisher, for instance some intermediate levels of the classification may be obscured from viewing by subscriber applications. In some embodiments, the publisher node can modify the information taxonomy to hide certain levels of classification and communicate a modified publisher information taxonomy.

After establishing the publisher channel, the publisher node monitors for data from data sources of the publisher (211). The publisher node can receive data collection updates from a data collector that monitors or periodically queries/retrieves data from data sources. Or the publisher node can include program code (e.g., drivers, defined interface commands, etc.) to retrieve data from data sources or query data sources for data.

When the publisher node detects data from a data source, the publisher node communicates the data (or information) to the broker with an indication of a topic based on the information taxonomy and the data source (213). If a data source is a temperature sensor, the data may be 32 and a character Celsius. The publisher node can convert this data into information since the integer and string become a temperature measurement when combined. The publisher node can then communicate the information to the broker. In some embodiments, the publisher node communicates the data to the broker and the broker stores the data as information (e.g., associates the integer and character to be communicated as a temperature measurement). The information taxonomy of the publisher will include a leaf classification corresponding to the data source. The publisher node can use the leaf node classification (leaf node in terms of a tree type of information taxonomy) as the topic identifier communicated to the broker. The topic identifier for a data source can also be a configured identifier.

FIG. 3 is a flowchart of example operations for a broker to create a publisher channel. The broker can be a service based on a Representational Transfer State (REST) architecture that specifies message request formats and exposes API functions for creating channels and sub-channels, establishing subscriptions to sub-channels, and servicing subscriptions. The broker service can also include a database to maintain the published information and subscription information. As another example, the broker can be a distributed service or cloud based service that comprises a software stack. The broker software stack can include program code in a platform independent programming language for channel/sub-channel creation and maintenance and subscription creation and servicing. The broker software stack can also include database software to maintain the published information (e.g., a NoSQL database).

The broker receives a channel creation request that indicates a publisher identifier (301). The broker can perform operations to validate the form of the channel creation request. If the request is malformed, the broker can return a failure response. The broker determines whether a publisher channel with that publisher identifier already exists (303). The broker can query a data store (e.g., key-value store or relational database management system) with the publisher identifier. With a compact publisher identifier (e.g., hash value), the broker can perform an efficient lookup.

If a publisher channel does not already exist with that identifier, then the broker creates the publisher channel (305). The broker can create a record or document in the data store of publisher channels maintained by the broker and/or update an index of publisher identifiers used as keys for the channel data store. Creation of a publisher channel can also be creation of a file, logical container (e.g., a volume or directory), or database identified by the publisher identifier. When information is received to be published in a sub-channel of the publisher channel, the information can be appended to the file, added as a data item in the logical container (e.g., queue entry, file, etc.), or inserted as an element, record, or entry of the database. After creating the publisher channel, the broker responds to the requesting publisher node with a successful acknowledgement (307).

The broker obtains the information taxonomy defined for the publisher and associates it with the publisher channel (309). As previously mentioned, the broker may receive the information taxonomy or a reference to the information taxonomy from a publisher node. The broker can associate the information taxonomy with the publisher channel by constructing a schema for the publisher channel based on the information taxonomy. For example, the broker can parse the information taxonomy and create a schema accordingly. The broker can validate the information taxonomy against a specification communicated to publisher nodes from the broker that defines a properly formed information taxonomy (e.g., XML, structure).

FIG. 4 is a flowchart of example operations for a broker to create a publisher sub-channel. The broker receives a message that indicates a publisher identifier, a topic identifier, and payload data (401). The payload data is the information to be published to subscribers. The broker determines whether a sub-channel for the topic identifier has already been created (403). The broker can access a data store with the publisher identifier (i.e., publisher channel identifier) and the topic identifier to determine whether a sub-channel for the identified topic already exists within the publisher channel. Since the publisher channel has multiple sub-channels corresponding to the multiple data sources of the publisher, the topic identifier will be a multi-level identifier. Referred to the example of an automobile, the publisher identifier would be a VIN while the topic identifier could be “engine/temperature.” The topic identifier may be a path through the hierarchical information taxonomy of the publisher.

If the sub-channel does not exist within the publisher channel, the broker creates the sub-channel with the optic identifier according to the information taxonomy for the publisher (405). Continuing with the automobile example, the publisher channel may include a sub-channel “cabin/atmosphere/temperature” and a sub-channel “body/external/temperature,” but not “engine/temperature.” If the payload data is engine temperature at a particular time instant and the topic identifier is “engine/temperature,” the broker will validate the topic identifier against the information taxonomy of the publisher and create the sub-channel if valid. The information taxonomy and/or a governing policy can indicate different degrees of granularity for sub-channels. Referring to the hotel example, hotel taxonomy information may include floor temperature as well as individual room temperatures. The hotel taxonomy information and/or governing policy can indicate different sub-channels to be created for a data source depending upon a rule or criterion. For instance, a temperature of a room may be published to a corresponding floor sub-channel instead of a room sub-channel if a security token is not provided with the subscription application.

After creation of the sub-channel or if the sub-channel already existed, the broker writes the payload data to the sub-channel (407). As examples, the broker can insert the payload data into a queue provisioned for the sub-channel; append the payload data to a file created for the sub-channel; insert a record or document into a database with the payload data as the value and a key as a combination of the publisher identifier and the topic identifier. Although the taxonomy information can be annotated or policies defined to create sub-channels at different granularities as described above, a publisher can also or instead include indication or instruction to the broker as to which sub-channel to publish the payload data. This can further limit exposure of information about the data source because a publisher can specify a sub-channel topic of “floor 14” for a room temperature when publishing a temperature to the broker. The broker is only aware of the sub-channel topic defined in the request. Upon successfully writing the payload data, the broker responds to the request with a successful acknowledgement (409).

After updating a data store(s) with the payload data, the broker communicates the payload data or information to subscriber(s) subscribed to the sub-channel according to the subscription(s) of the subscriber(s) (411). A subscription may be push based (e.g., the broker notifies a subscriber of an update to the sub-channel) or pull based (e.g., the broker maintains flags to indicate updates to a sub-channel to guide a subscriber when retrieving information from the sub-channel). The broker may mark information when added to a sub-channel and periodically evaluate sub-channels to generate notifications or generate a notification proximate with addition of information to a sub-channel.

FIG. 5 is a flowchart of example operations for a subscriber application to discover and subscribe to a publisher sub-channel. As previously mentioned, a subscriber application can be a third party application that interacts with an intermediary notification service with request messages that conform to a message specification defined for the intermediary notification service. For example, a subscriber application forms HTTP messages according to an eXtensible markup language (XML) defined message specification for a RESTful intermediary notification service.

A subscriber application discovers publishers based on a dynamic filter criterion (501). For example, a subscriber application can search for publishers based on a geographic location (e.g., specified location or current location of a device hosting the subscriber application). Using the hotel based example, the subscriber application can search for hotels within a certain distance of a global positioning satellite (GPS) coordinates of a host device.

The subscriber application selects a publisher from the discovered publishers (503). A subscriber application can select based on machine learning, user interface input, preconfigured parameters, etc.

The subscriber application then obtains a publisher identifier that identifies the selected publisher (505). The publisher identifier has been previously published to an internet realm of the publisher (e.g., website of the publisher, a third party web site that includes information about the publisher, etc.). Selection of the publisher includes indication of the internet realm (e.g., website address bound to a graphical element that was selected). The subscriber application can also automatically select from a list of search results that indicate internet realms of publishers (e.g., select nearest publisher or publisher in browsing history). The subscriber application reads the publisher identifier that has been published to the internet realm (e.g., reads a VIN, reads a physical address and publisher name, etc.).

The subscriber application queries the broker with the publisher identifier (507). The publisher identifier from the subscriber application may be different than the publisher's channel identifier. The publisher identifier may be a canonical identifier for the class of publishers. The broker may use compact forms of the canonical identifiers (e.g., hash values) as channel identifiers. In that case, the broker will determine the hash value of the publisher identifier to derive the channel identifier. The broker may be exposed to the subscriber application as a publicly available broker service, be predefined for the subscriber application, be indicated along with the publisher identifier, etc. The subscriber application communicates a broker compliant request to the broker with the publisher identifier.

Disregarding an interruption, the subscriber application receives from the broker an indication of the information taxonomy defined for the selected publisher identified in the query (509). This allows a subscriber application to navigate and select from the sub-channels offered by the publisher. For security and/or user experience, a publisher may limit exposure of the information taxonomy to subscriber applications. For example, visibility of maintenance sub-channels for a hotel may be limited to subscriber applications that can satisfy a security policy that governs the maintenance sub-channels. Thus, the subscriber application may only receive a portion of the information taxonomy defined for the selected publisher. The subscriber application can present the received portion via a user interface with selectable indications for the sub-channels presented. If a publisher has defined a policy or annotated taxonomy information to expose taxonomy at varying degrees of granularity depending upon a condition or criterion, the subscriber application may be provided a filtered/modified version of the sub-channels. For instance, the subscriber application may be provided with information and an indication of a sub-channel that corresponds to a higher or lower level of the hierarchical information taxonomy than the sub-channel that directly corresponds to the data source of that information. The subscriber application selects a publisher sub-channel based on the indication of the information taxonomy (511). For example, the subscriber application detects user input that selects a sub-channel(s) or the subscriber application selects a sub-channel based on configuration information (e.g., a temporary security token for a hotel room).

Based on the selected publisher sub-channel, the subscriber application requests a subscription to the sub-channel with the subscriber identifier (513). The indication of the information taxonomy comprises the topic identifiers corresponding to the sub-channels based on the information taxonomy. The subscriber application determines the topic identifier or sub-channel path based on the selection and includes it in the subscription request. The subscriber application creates the subscription request with an identifier of the subscriber application (e.g., identifier of the application and host device, user identifier, etc.) to allow the broker to maintain the subscription for the subscriber application.

Variations

The channel and sub-channel creation example illustrations allow for dynamic creation of sub-channels. In the example illustrations, a broker can create a sub-channel when information indicating a topic of first impression within a publisher channel is received from a publisher node. Embodiments can impose a constraint that a sub-channel be explicitly created by a publisher node and queue or reject information received for publication to a non-existent sub-channel of a publisher. A publisher node can request creation of sub-channels based on the publisher's information taxonomy and/or request creation of sub-channels when information to be published is initially received for a sub-channel.

The preceding example illustrations refer to publishers with pre-defined or established associations with collections of data sources: a hotel publisher is associated with sensors throughout the hotel and an automobile is associated with the sensors built as part of the automobile. Embodiments can also create a publisher channel for an ad-hoc collection of data sources. For example, drones with various sensors attached can dynamically form groups to collect data about a particular site or environment and the constituents of the drone group can change.

The preceding example illustrations provide a few examples of annotating information taxonomies and/or associating security policies with information taxonomies to limit visibility of a publisher's information taxonomy. The preceding examples limit visibility for branch of the information taxonomy (e.g., all maintenance sub-channels) and/or for a level (e.g., publish a room temperature to a floor sub-channel instead of a room sub-channel). In some embodiments, the broker can obtain different information taxonomies for a publisher. The different information taxonomies will have a different structure to vary exposure of structural information. When creating a sub-channel or updating a sub-channel with information published form a publisher node, the broker may select a one of multiple alternate channels established for a publisher node each of which have different structures for controlling visibility, whether by level or branch, of the publisher's information taxonomy. The publisher node can specify the publisher channel as well as the topic identifier for the sub-channel. Likewise, the broker will select the appropriate one of the publisher's channels for a subscriber application based on a condition or criterion (e.g., security token in request or type of subscriber application).

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in the figures generally indicate creation of publisher channels before communicating an information taxonomy of a publisher, but embodiments can incorporate the communication of the information taxonomy into the channel creation. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

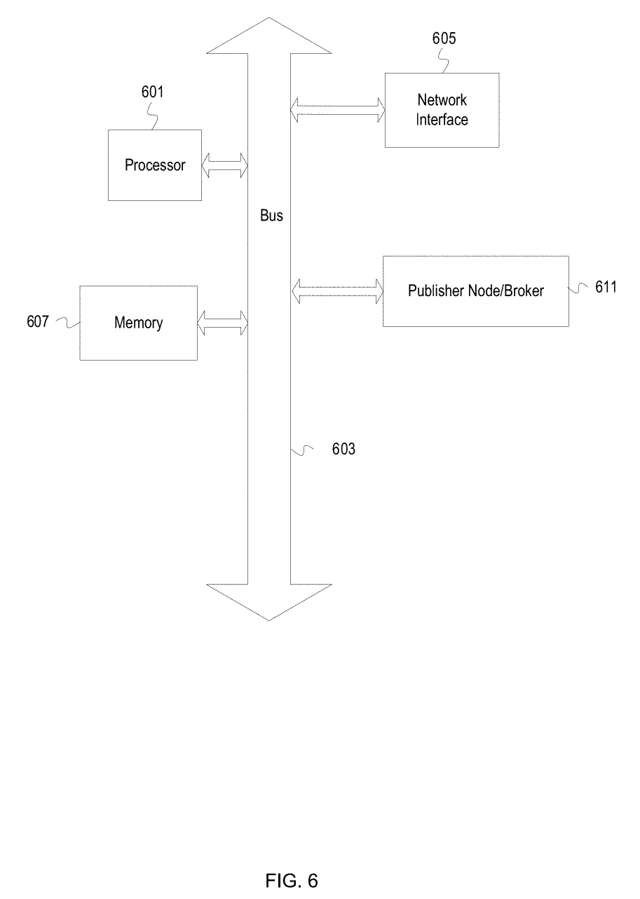

FIG. 6 depicts an example computer system with a publisher node or broker according to the previously described paradigm. The computer system includes a processor 601 (possibly including multiple processors, multiple cores, multiple processing nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a publisher node or a broker 611. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

While the aspects of the disclosure are described with reference to various implementations and exploitations, it will be understood that these aspects are illustrative and that the scope of the claims is not limited to them. In general, techniques for a pub/sub system for publishers with multiple data sources and information taxonomies based on attributes of the publishers as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
in response to a channel creation request from a publisher node, creating an information channel identified by a first identifier of a publisher corresponding to the publisher node, wherein the identifier of the publisher is unique within a class of publishers that includes the publisher;
associating an information taxonomy of the publisher with the channel, wherein the information taxonomy is based on attributes of the publisher; and
creating information sub-channels within the channel based, at least in part, on receipt of information from the publisher node and topic identifiers corresponding to the information taxonomy.

2. The method of claim 1, wherein the topic identifiers comprise paths of the information taxonomy.

3. The method of claim 1, wherein creating the information sub-channels is also based on receipt of the first identifier from the publisher node.

4. The method of claim 3, wherein a publication request comprises a first of the topic identifiers, the first identifier, and information from a first of the data sources corresponding to the first topic identifier.

5. The method of claim 1, wherein the first identifier comprises a hash value of a second identifier of the publisher that is a canonical publisher identifier for the class of publishers.

6. The method of claim 5 further comprising:
communicating at least part of the information taxonomy to a subscriber application based on a query from the subscriber application that indicates the second identifier;
based on receipt of a first path in the communicated part of the information taxonomy, creating a subscription to a first sub-channel corresponding to the first path within the channel identified by the first identifier.

7. The method of claim 6 further comprising determining a security policy that governs the information taxonomy and excluding at least a part of the information taxonomy for communication to the subscriber application based on the security policy.

8. The method of claim 1, wherein creating the information sub-channels comprises:
creating a first information sub-channel for publishing information from a first data source associated with the publisher; and
creating a second information sub-channel for publishing the information from the first data source, wherein the first information sub-channel corresponds to a different level of the information taxonomy than the second information sub-channel.

9. The method of claim 1 further comprising:
based on receipt of a request to subscribe to one of the information sub-channels of the publisher, determining a degree of granularity of the information taxonomy that can be exposed; and
responding to the request with information from a first data source and indication of a first of the information sub-channels, wherein the information is from a first data source that corresponds to a second information sub-channel that corresponds to a different degree of granularity of the information taxonomy than the first information sub-channel.

10. One or more non-transitory machine-readable media comprising program code for a publisher taxonomy based publisher-subscriber system, the program code to:
in response to a channel creation request from a publisher node, create an information channel identified by a first identifier of a publisher corresponding to the publisher node, wherein the identifier of the publisher is unique within a class of publishers that includes the publisher;
associate an information taxonomy of the publisher with the channel, wherein the information taxonomy is based on attributes of the publisher; and
create information sub-channels within the channel based, at least in part, on receipt of information from the publisher node and topic identifiers corresponding to the information taxonomy.

11. The non-transitory machine-readable media of claim 10, wherein the topic identifiers comprise paths of the information taxonomy.

12. The non-transitory machine-readable media of claim 10, wherein the program code to create the information sub-channels comprises the program code to create the information sub-channels also based on receipt of the first identifier from the publisher node.

13. The non-transitory machine-readable media of claim 10, wherein the program code to create the information sub-channels comprises program code to:
create a first information sub-channel for publishing information from a first data source associated with the publisher; and
create a second information sub-channel for publishing the information from the first data source, wherein the first information sub-channel corresponds to a different level of the information taxonomy than the second information sub-channel.

14. The non-transitory machine-readable media of claim 10 further comprising program code to:
based on receipt of a request to subscribe to one of the information sub-channels of the publisher, determine a degree of granularity of the information taxonomy that can be exposed; and
respond to the request with information from a first data source and indication of a first of the information sub-channels, wherein the information is from a first data source that corresponds to a second information sub-channel that corresponds to a different degree of granularity of the information taxonomy than the first information sub-channel.

15. An apparatus comprising:
a processor; and
a machine-readable medium having program code executable by the processor to cause the apparatus to,
create an information channel identified by a first identifier of a publisher corresponding to the publisher node in response to a channel creation request from the publisher node, wherein the identifier of the publisher is unique within a class of publishers that includes the publisher;
associate an information taxonomy of the publisher with the channel, wherein the information taxonomy is based on attributes of the publisher; and
create information sub-channels within the channel based, at least in part, on receipt of information from the publisher node and topic identifiers corresponding to the information taxonomy.

16. The apparatus of claim 15, wherein the topic identifiers comprise paths of the information taxonomy.

17. The apparatus of claim 15, wherein the program code to create the information sub-channels comprises the program code executable by the processor to cause the apparatus to create the information sub-channels also based on receipt of the first identifier from the publisher node.

18. The apparatus of claim 15, wherein the program code to create the information sub-channels comprises the program code executable by the processor to cause the apparatus to:
create a first information sub-channel for publishing information from a first data source associated with the publisher; and
create a second information sub-channel for publishing the information from the first data source, wherein the first information sub-channel corresponds to a different level of the information taxonomy than the second information sub-channel.

19. The apparatus of claim 15, wherein the machine-readable medium further comprises program code executable by the processor to cause the apparatus to:
based on receipt of a request to subscribe to one of the information sub-channels of the publisher, determine a degree of granularity of the information taxonomy that can be exposed; and
respond to the request with information from a first data source and indication of a first of the information sub-channels, wherein the information is from a first data source that corresponds to a second information sub-channel that corresponds to a different degree of granularity of the information taxonomy than the first information sub-channel

20. The apparatus of claim 15, wherein the first identifier comprises a hash value of a second identifier of the publisher that is a canonical publisher identifier for the class of publishers.
